(19) United States
(12) Patent Application Publication
(10) Pub. No.: US 2014/0272369 A1
(43) Pub. Date: Sep. 18, 2014

(54) PERVIOUS CONCRETE PERMEABLE GROUT

(71) Applicant: Jonathan Todd King, Wilmington, NC (US)

(72) Inventor: Jonathan Todd King, Wilmington, NC (US)

(21) Appl. No.: 14/207,743

(22) Filed: Mar. 13, 2014

Related U.S. Application Data
(60) Provisional application No. 61/781,191, filed on Mar. 14, 2013.

(51) Int. Cl. C04B 16/04; C04B 14/06; C04B 20/10

(52) U.S. Cl. CPC C04B 16/04; C04B 20/1055; C04B 20/1037; C04B 14/06
USPC 428/220; 523/400; 427/136; 428/221

(57) ABSTRACT

A water pervious concrete surface is described that is formed of a water pervious layer of concrete having interconnected voids, and a water permeable grout within the voids in the pervious layer. The permeable grout is formed of sand particles bonded in an open matrix with a two-part epoxy resin.

This application claims the benefit of the filing date of U.S. Provisional Application Ser. No. 61/781,191, filed Mar. 14, 2013, which is incorporated herein by reference in its entirety.

### FIELD OF THE INVENTION

The present invention relates generally to pervious concrete surfaces, and in particular to coatings for such surfaces that prevent accumulation of dirt and other debris within the pervious concrete voids without blocking the permeability of the concrete.

### BACKGROUND OF THE INVENTION

Pervious concrete, also called permeable concrete, porous concrete, no-fines concrete or gap graded concrete, is a mixture of hydraulic cement, coarse aggregates (stone), water and admixtures. Pervious concrete contains little or no sand, and is sometimes referred to as a “no-fines” concrete. The cement and water forms a paste that binds the coarse aggregates together.

Only enough paste is added to the mix to glue the aggregate together where they touch each other, but not enough to fill all of the spaces between the aggregates. A typical pervious concrete mixture will contain about 17-25% void space within the concrete. Many of the void spaces within the pervious concrete will be interconnected, forming channels that allow water and air to pass freely through the pavement structure.

Pervious concrete is used as an alternative to asphalt and non-pervious concrete in the construction of walkways, driveways or roadways, parking lots, and the like. Unlike asphalt and non-pervious concrete, pervious concrete captures stormwater, allowing it to seep into the ground. As a result, pervious concrete is instrumental in recharging groundwater, reducing stormwater runoff, and meeting U.S. Environmental Protection Agency (EPA) stormwater regulations. This pavement technology creates more efficient land use by eliminating the need for retention ponds and other stormwater management devices.

A disadvantage of conventional pervious concrete is the accumulation over time of dirt, sand and other debris within the voids of the pervious concrete, blocking or significantly reducing the permeability at the concrete. To address this disadvantage, permeable concrete must be cleaned regularly e.g., by vacuuming or pressure washing. Cleaning is costly and time comsuming, and may not entirely remove the debris blocking the concrete voids. Thus, there is a need for an improved alternative to cleaning that will permit the use of pervious concrete with its attendant advantage.

### SUMMARY OF THE INVENTION

This need is addressed by the present invention by providing a grout that can be used to fill the voids of pervious concrete without significantly reducing permeability. The grout, by filling the voids, prevents significant accumulation of debris within the voids, and as a result the need for frequent vacuuming or pressure washing. At the same time, since the grout is itself permeable, the advantages resulting from using pervious concrete are not lost.

Generally, the present compositions are comprised of sand admixed with a two-part epoxy resin that acts as a binder for the sand particles to create a void matrix allowing water to pass between the sand particles. A cross-linkable epoxy polymer and a binder, or cross-linking agent, is used to produce the epoxy resin. The exact chemical compositions of the epoxy polymer and binder are not critical to the present invention, so long as the resulting resin is capable of forming a matrix to bind together the sand particles of the composition, while leaving a void space to allow sufficient water penetration.

The epoxy polymer is desirably film-forming and water-dispersable. The polymer should also be liquid and cross-linkable at room temperature. The epoxy polymer may be saturated or unsaturated, cycloaliphatic, allylcyclic or heterocyclic, and may be substituted with halogen atoms, hydroxyl groups, ether radical, etc. The polymer is preferably difunctional, but may be trifunctional or polyfunctional. A suitable polymer is a polymer of Bisphenol-A and epichlorohydrin.

The curing agent is preferably a water compatible polyamine. Suitable curing agents include, but are not limited to, ethylene diamine, triethylene tetraamine, and the like.

Permeability of the grout will depend on the size of the sand particles. Normally, the sand will have a minimum sieve size of 12-40 and a maximum sieve size of 8-16. The mixture is preferably designed with a permeability rate exceeding 250 in/hr. All sand should be “washed, dried and sieved” to ensure there are no “fines” in the sand. Sand that has even is low percentage of fines, below size 40, will decrease the permeability of the grout and be difficult to remove from the surface during the installation process. A good source for acceptable media are sand blasting supply companies, which typically carry filter sands with sieve sizes of 20 or 22.

The grout is normally applied to the surface of a layer of permeable concrete that is on top of an aggregate base layer, e.g., gravel or stone. For most applications, the base layer will have a thickness of 4 to 6 inches and the pervious concrete will have a thickness of 4 to 6 inches.

The grout is prepared by intimately mixing the sand, two-part epoxy resin, and water, e.g., in a powered concrete mixer. The surface to be treated is then lightly sprayed with water, and the grout is uniformly applied to the surface, making sure that the grout penetrates into pervious concrete voids. Excess grout is then removed from the surface.

It will be understood that the grout composition may contain other ingredients so long as the additional ingredients do not significantly interfere with the permeability of the grout. For example, a pigment can be added to the mixture. Colored sand can be used instead of adding pigment to the mixture.

### BRIEF DESCRIPTION OF THE DRAWINGS

FIG. 1 is a sectional side view of pervious concrete incorporating the permeable grout of the invention.

FIG. 2 is a detailed sectional side view of pervious concrete of FIG. 1.

FIG. 3 is a detailed sectional side view of permeable grout.

### DETAILED DESCRIPTION OF THE INVENTION

As an illustration of the method of the invention, a pervious concrete driveway, previously cleaned, was surfaced with the water-permeable grout. The grout composition was prepared using a small concrete mixer.

First, 40 lbs. of filtered sand with a minimum sieve size of 12-40 and a maximum sieve size of 8-16 was added to the mixer. 1.78 lbs. of epoxy polymer and 1 lb. of binder were then added along with sufficient water to create a workable mixture. The mixture was then mixed for approximately four minutes to blend the components and coat the sand particles.

The concrete surface was lightly sprayed with water and the grout was then spread over the surface with a squeegee, filling the voids in the concrete. Care was taken to ensure that all voids were filled. Penetration of the grout into the surface of the concrete was about 0.5 inch. The surface was broomed to remove any excess grout. After application, the grout was within the voids in the pervious concrete surface instead of forming a layer over the pervious concrete. The grout was then allowed to cure for at least five hours before any traffic on the surface. Typically, 35 lbs. to 40 lbs. of filtered 12-40 sand and grout will yield a surface coverage of approximately 75 sf to 90 sf.

A sample of pervious concrete prepared in a manner similar to the proceeding steps was tested for permeability. The sample, which had a thickness of 3.5 inches, was tested by pouring water into a ring mounted on the top of the sample with the edges of the ring at the interface with the concrete being sealed. Two tests were made, with the sample being found to have an average infiltration rate of 283.13 inches/hour.

As illustrated in the drawings, the resultant permeable concrete 10 is shown on a base layer 12. Concrete 10, illustrated in detail in FIG. 2, is comprised aggregate 14 held together by a matrix of hydraulic cement 16 leaving void space 18 for water permeability. A portion of void space 18 is filled with permeable grout 20, illustrated in detail in FIG. 3. Grout 20 is comprised of sand 22 held together by a matrix of a two-part resin 24.

Certain modifications and improvements will occur to those skilled in the art upon a reading of the foregoing description. It should be understood that all such modifications and improvements have been deleted herein tor the sake of conciseness and readability but are properly within the scope of the following claims.

What is claimed is:

1. Permeable grout useful in filling the voids in pervious concrete comprising:
a) sand; and
b) a two-part epoxy resin binding said sand into a void matrix allowing water to pass through said grout.

2. The grout of claim 1, wherein said epoxy resin is formed by reacting a cross-linkable epoxy polymer with a cross-linking agent.

3. The grout of claim 2, wherein said polymer is a film-forming water-dispersable, liquid that is cross-linkable at room temperature.

5. The grout of claim 2, wherein said cross-linking agent is a water-compatible polyamine.

6. The grout of claim 5, wherein said polyamine is ethylene diamine, triethylene tetraamine, or a mixture thereof.

7. The grout of claim 1, wherein said sand has a minimum sieve size of 12-40 and a maximum sieve size of 8-16.

8. A method of filling the void in pervious concrete to reduce the accumulation of debris in the voids while allowing the penetration of water through the voids comprising:
a) forming a grout by mixing sand with a cross-linkable epoxy polymer and a cross-linking agent reactable with said polymer to form a cross-linked epoxy resin; and
b) brushing said grout into said voids.

9. The method of claim 8, wherein said grout is brushed into said voids to a depth of at least 0.5 inch.

10. The method of claim 8, wherein said polymer is a film-forming, water-dispersable, liquid that is cross-linkable at room temperature.

11. The method of claim 8, wherein said cross-linking agent is a water-compatible polyamine.

12. The method of claim 11, wherein said polyamine is ethylene diamine, triethylene tetraamine, or a mixture thereof.

13. The method of claim 8, wherein said sand has a minimum sieve size of 12-40 and a maximum sieve size of 8-16.

14. A water pervious concrete surface comprising:
a) a water pervious layer of concrete having interconnected voids; and
b) a water permeable grout within the voids in said concrete layer, said grout comprising sand particles bonded in an open matrix with a two-part epoxy resin.

15. The surface of claim 14, wherein said concrete layer has a thickness of at least 4 inches and said grout fills at least the upper 0.5 inch of the voids in said layer.

16. The surface of claim 14, wherein said layer is comprised of hydraulic cement, aggregate and water, and includes less that about 5 percent sand.

17. The surface of claim 14, wherein said concrete layer has a void space of about 17-25%.

18. The surface of claim 14, wherein said resin is formed by reacting a cross-linkable epoxy polymer an a cross-linking agent.

19. The surface of claim 18, wherein said cross-linking agent is a water-compatible polyamine.

20. The method of claim 14, wherein said sand has a minimum sieve size of 12-40 and a maximum sieve said of 8-16.
